(19) United States
(12) Patent Application Publication
(10) Pub. No.: US 2026/0035575 A1
(43) Pub. Date: Feb. 5, 2026

(54) NANOCOMPOSITE STRUCTURES

(71) Applicant: CORNING INCORPORATED, CORNING, NY (US)

(72) Inventors: YANG LI, PAINTED POST, NY (US); HAONAN WANG, ZIBO (CN)

(21) Appl. No.: 19/254,881

(22) Filed: Jun. 30, 2025

(30) Foreign Application Priority Data
Jul. 30, 2024 (CN) 202411040122.3

(51) Int. Cl. C09D 5/16; C08K 3/22; C08K 3/36; C09D 5/00; C09D 7/40; C09D 7/61; C09D 183/04

(52) U.S. Cl. CPC C09D 5/1618; C09D 5/006; C09D 5/1675; C09D 7/61; C09D 7/67; C09D 183/04; C08K 2003/2241; C08K 2003/2244; C08K 3/36; C08K 2201/011

(57) ABSTRACT

A structure may include a nanoparticle structure comprising a first primary surface and a second primary surface opposite the first primary surface, one or more layers of oxide nanoparticles disposed between and constituting the first and second primary surfaces; an interior pore volume located in spaces between oxide nanoparticles; and a binder provided in the interior pore volume and covalently bonded to at least a portion of the oxide nanoparticles.

### CROSS-REFERENCE TO RELATED APPLICATION

This application claims the benefit of priority under 35 U.S.C. § 119 of Chinese Patent Application No. 202411040122.3 filed on Jul. 30, 2024, the content of which is relied upon and incorporated herein by reference in its entirety.

### FIELD

The disclosure relates generally to functional coatings, including structures having a functional coating disposed thereon. More particularly, the disclosure relates to structures including a nanoparticle structure that in some aspects can act as a functional coating, which nanoparticle structure may include one or more layers of oxide nanoparticles and an interior pore volume located in spaces between oxide nanoparticles, and a binder provided in the interior pore volume and covalently bonded to at least a portion of the oxide nanoparticles.

### BACKGROUND

Various products, including consumer electronics, car displays, and so forth, typically include glass housings and/or cover substrates disposed over a display, a lens, and/or a sensor of the product. Such glass housings and/or cover substrates are susceptible to adverse processes including the adsorption of contaminants from air and fogging, for example. Coatings have been used to try to address such concerns; however, known coatings can suffer from poor durability and/or short functional lifetimes, among other drawbacks.

### SUMMARY

The disclosure provides structures including a nanoparticle structure including a first primary surface and a second primary surface opposite the first primary surface; one or more layers of oxide nanoparticles disposed between and constituting the first and second primary surfaces; an interior pore volume located in spaces between oxide nanoparticles; and a binder provided in the interior pore volume and covalently bonded to at least a portion of the oxide nanoparticles.

The disclosure further provides methods of preparing a structure of the disclosure, the methods including: (i) depositing a nanoparticle structure on a substrate, wherein the nanoparticle structure includes: a first primary surface and a second primary surface opposite the first primary surface, the first primary surface being proximal to the substrate; one or more layers of oxide nanoparticles disposed between and constituting the first and second primary surfaces; and an interior pore volume located in spaces between oxide nanoparticles; (ii) infiltrating the interior pore volume with a reactive binder, and optionally (iii) removing the nanoparticle structure from the substrate.

Further aspects and advantages will be apparent to those of ordinary skill in the art from a review of the following detailed description. While the compositions and methods are susceptible of aspects in various forms, the description hereafter includes specific aspects with the understanding that the disclosure is illustrative, and is not intended to limit the disclosure to the specific aspects described herein

### BRIEF DESCRIPTION OF THE DRAWINGS

While the specification concludes with claims particularly pointing out and distinctly claiming the subject matter, which is regarded as forming the present invention, it is believed that the invention will be better understood from the following description taken in conjunction with the accompanying drawings.

FIG. 1A shows a nanoparticle structure of the disclosure including a first primary surface and a second primary surface opposite the first primary surface; layers of oxide nanoparticles disposed between and constituting the first and second primary surfaces; and an interior pore volume located in spaces between oxide nanoparticles.

FIG. 1B shows the structure of FIG. 1A including the optional substrate, wherein the first primary surface of the nanoparticle structure is proximal to the substrate.

FIG. 2 shows an example of a nanoparticle structure of the disclosure including four layers, wherein the nanoparticle structure includes first layers of oxide nanoparticles (i) and second layers of oxide nanoparticles (ii), wherein the oxide nanoparticles in the first layers (i) are substantially the same (represented by the same color shading) and the oxide nanoparticles in the second layers (ii) are substantially the same (represented by the same color shading), but different from the oxide nanoparticles in the first layers (i) (represented by different color shading).

FIG. 3 shows the placement of the binder in the interior pore volume of a nanoparticle structure of the disclosure; although FIG. 3 depicts the binder as particles within the interior pore volume, it will be understood that the binder is present as a matrix structure.

FIG. 4A is a schematic showing the nanoparticle structure of the disclosure provided on one surface of a substrate.

FIG. 4B is a schematic showing the nanoparticle structure of the disclosure provided on two surfaces of a substrate.

FIG. 5 shows the total thickness of a structure of the disclosure prepared from SiO₂ nanoparticles including 4 consecutive coatings of nanoparticles using the same deposition parameters.

FIG. 6A shows the evolution of coating thickness and refractive index during abrasion testing for up to 500k cycles (1 million single strips) of samples of the disclosure subjected to the 85/85 pre-treatment. The stable refractive index and thickness indicate no damage or removal of the nanoparticle structure.

FIG. 6B shows the evolution of WCA during abrasion testing for up to 500k cycles (1 million single strips) of samples of the disclosure subjected to the 85/85 pre-treatment. The SEM image after 500k abrasion cycles (inset) shows no visible scratch on the surface (scale bar is 1 mm).

FIG. 7 shows the evolution of WCA over time of samples of the disclosure and comparative samples.

FIG. 8 shows the evolution of WCA over time for samples of the disclosure and comparative samples, and the WCA of the samples after different cleaning methods were applied.

FIG. 9 shows the evolution of WCA over time for a sample of the disclosure, a comparative sample of bare glass, and a comparative sample glass with a coating of nanoparticles only.

### DETAILED DESCRIPTION

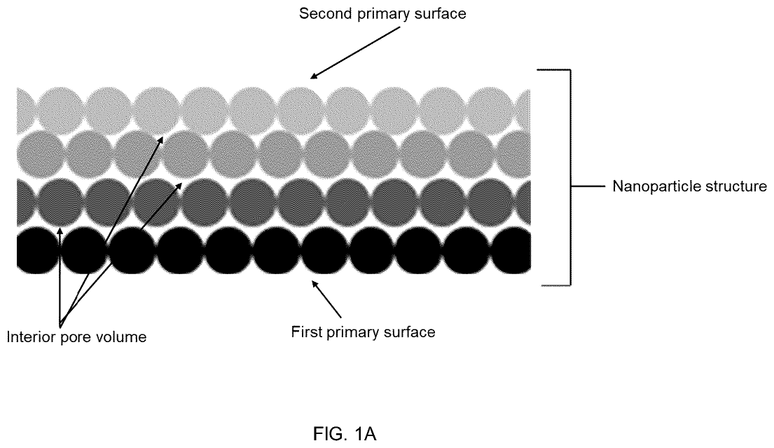

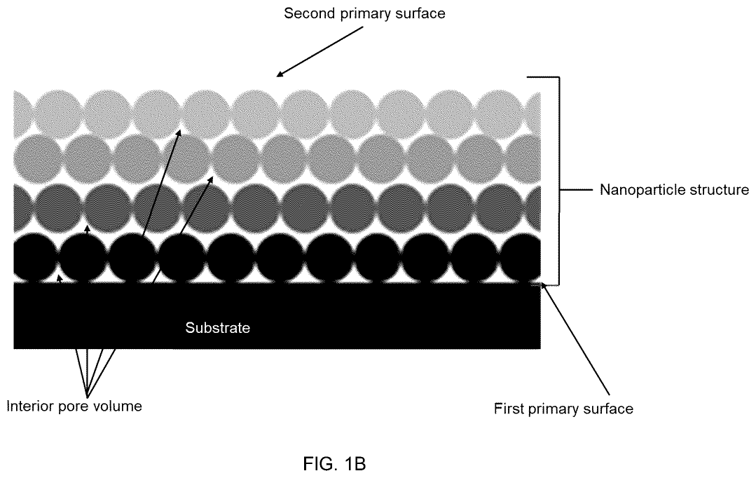

The disclosure provides structures including a nanoparticle structure. As shown in FIG. 1A, the nanoparticle structure can include a first primary surface and a second primary surface opposite the first primary surface; one or more layers of oxide nanoparticles disposed between and constituting the first and second primary surfaces; and an interior pore volume located in spaces between oxide nanoparticles. A binder is provided in the interior pore volume and covalently bonded to at least a portion of the oxide nanoparticles (not shown). As shown in FIG. 1B, the structures can optionally include a substrate, wherein the first primary surface of the nanoparticle structure is proximal to the substrate.

The oxide nanoparticles can generally be any oxide nanoparticle that can form an oxide bond with the binder. The oxide nanoparticles can include a metal or a metalloid. The oxide nanoparticles can include SiO₂, ZrO₂, TiO₂, Al₂O₃, MgO, HfO₂, ZnO, or any combination thereof. The oxide nanoparticles can include SiO₂, ZrO₂, TiO₂, or any combination thereof.

The oxide nanoparticles can be selected to customize the optical properties of the structure, for example, to provide an anti-reflective coating. The type and combinations of each nanoparticle and nanoparticle layer in the nanoparticle structure can be selected for different desired optical properties as is known in the art. The oxide nanoparticles in each layer of the one or more layers of oxide nanoparticles in the nanoparticle structure, independently, can be substantially the same. As used herein, and unless specified otherwise, oxide nanoparticles in a given layer are “substantially the same” if at least 90%, by volume, of the oxide nanoparticles in the layer are the same, for example, 90% of the oxide nanoparticles are SiO₂ nanoparticles.

The nanoparticle structure can include two or more layers of oxide nanoparticles. The two or more layers of oxide nanoparticles can be substantially the same or different. As used herein, and unless specified otherwise, two or more layers of oxide nanoparticles are “substantially the same” if the compositional make-up of the layers has a variance of less than 10%. For example, a first layer comprising a 50:50 (by weight) mix of TiO₂ nanoparticles and SiO₂ nanoparticles is substantially the same as a second layer comprising a 55:45 mix of TiO₂ nanoparticles and SiO₂ nanoparticles. As one example, as shown in FIG. 1A and FIG. 1B, for a nanoparticle structure comprising four layers, the oxide nanoparticles can include four different layers, wherein the oxide nanoparticles in each layer are substantially the same as each other (represented by the same color shading), while the composition of each layer of oxide nanoparticles can be different (represented by different color shading).

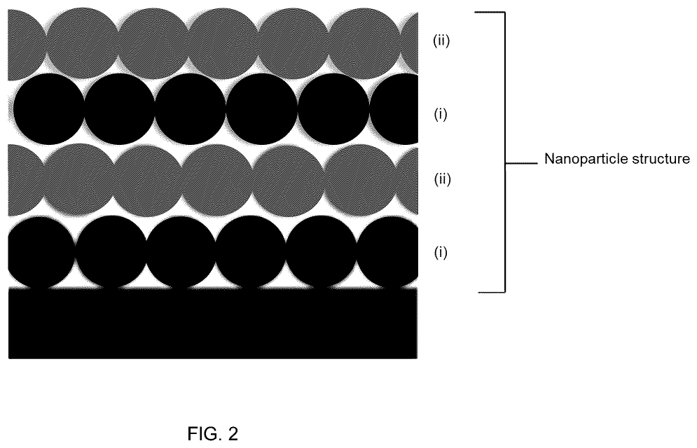

In nanoparticle structures including two or more layers of oxide nanoparticles, the nanoparticle structure can include a first layer of oxide nanoparticles and a second layer of oxide nanoparticles, wherein the oxide nanoparticles in the first layer are substantially the same and the oxide nanoparticles in the second layer are substantially the same but different from the oxide nanoparticles in the first layer. As an example, as shown in FIG. 2, for a nanoparticle structure comprising four layers, the nanoparticle structure can include a first layer of oxide nanoparticles (i) and a second layer of oxide nanoparticles (ii), wherein the oxide nanoparticles in the first layer (i) are substantially the same (represented by the same color shading) and the oxide nanoparticles in the second layer (ii) are substantially the same (represented by the same color shading), but different from the oxide nanoparticles in the first layer (i) (represented by different color shading). The nanoparticle structure can include alternating layers of a first layer of oxide nanoparticles and a second layer of oxide nanoparticles, as shown in FIG. 2.

In nanoparticle structures including two or more layers of oxide nanoparticles, the nanoparticle structures can be free of intervening polymer layers. As shown in FIG. 1A, for example, individual nanoparticle layers can be stacked directly.

The size of the oxide nanoparticles is not particularly limited and can be selected to control the interior pore volume. In general, as the size of the oxide nanoparticles increases, the space between the nanoparticles increases. The oxide nanoparticles can have an average particle size in a range of 5 nm to 500 nm, 5 nm to 450 nm, 5 nm to 400 nm, 5 nm to 350 nm, 5 nm to 300 nm, 5 nm to 250 nm, 5 nm to 200 nm, 5 nm to 150 nm, 5 nm to 125 nm, 5 nm to 100 nm, 5 nm to 75 nm, 5 nm to 50 nm, 5 nm to 40 nm, 5 nm to 15 nm, 10 nm to 30 nm, or 15 nm to 25 nm. The average particle size of the oxide nanoparticles in each layer, independently, can be substantially the same. As used herein, and unless specified otherwise, the average particle size of oxide nanoparticles in a given layer are “substantially the same” if the average particle size in said layer has a variance of less than 10%. In nanoparticle structures including two or more layers of oxide nanoparticles, the average particle size of the oxide nanoparticles in each layer can be substantially the same or different. As used herein, and unless specified otherwise, the average particle size of oxide nanoparticles in a first layer and a second layer are “substantially the same” if the average particle size if a variance in average particle size for the oxide nanoparticles of the first layer and the second layer is less than 10%. Average particle size can be determined using transmission electron microscopy. For non-spherical particles, the average particle size refers to the average largest dimension.

The thickness of the nanoparticle structure is not particularly limited and can be in a range of 5 nm to 5000 nm. Without intending to be bound by theory, it is believed that for applications wherein the nanoparticle structure is used in a superhydrophilic coating, as the thickness of the nanoparticle structure increases the hydrophilicity and lifetime of the coating increases due to (a) increased interior pore volume for distributing water throughout the bulk of the nanoparticle structure and (b) the presence of pore volume deep in the structure (relative to the second primary surface) that is less sensitive to contaminants in air than pore volume close to the second primary surface, resulting in longer lifetimes. Further, without intending to be bound by theory, it is believed that as the thickness of the nanoparticle structure increases beyond 5000 nm, the likelihood of cracks forming in the nanoparticle structure increases. The thickness of the nanoparticle structure can be in a range of 5 nm (e.g., a monolayer of oxide nanoparticles) to 5000 nm, 5 nm to 4000 nm, 5 nm to 3000 nm, 5 nm to 2000 nm, 5 nm to 1000 nm, 10 nm to 1000 nm, 15 nm to 800 nm, 20 nm to 700 nm, 50 nm to 600 nm, 100 nm to 500 nm, 200 nm to 500 nm, or 400 nm to 500 nm.

The interior pore volume of the nanoparticle structures of the disclosure corresponds to the spaces between the oxide nanoparticles, as shown in FIG. 1A, and the spaces between the oxide nanoparticles and a substrate, when a substrate is present, as shown in FIG. 1B. In general, the more densely packed the oxide nanoparticles, the less interior pore volume is present. The nanoparticle structures of the disclosure generally include a random packing of oxide nanoparticles as a result of the oxide nanoparticles being deposited from a liquid composition, as disclosed herein. The packing density and resulting interior pore volume are properties of the selection of oxide nanoparticle. The packing density and resulting interior pore volume can be varied by mixing oxide nanoparticles of different sizes at different ratios and/or changing the nanoparticle shape. For a random packing of homogeneous substantially spherical oxide nanoparticles, the mean pore diameter is about 30% of the diameter of the oxide nanoparticles. The interior pore volume can account for at least 10%, 15%, 20%, 25%, 30%, 35%, 40%, 45%, or 50%, by volume, of the total volume of the nanoparticle structure; additionally or alternatively, the interior pore volume can account for 50%, 45%, 40%, 35%, 30%, 25%, 20%, 15%, or 10% or less, by volume, of the total volume of the nanoparticle structure. For clarity, any two of the foregoing open ended ranges can be combined to form a closed range. For example, 10-50%, 10-45%, 10-40%, 10-35%, 10-30%, 10-25%, 10-20%, 10-15%, 15-50%, 15-45%, 15-40%, 15-35%, 15-30%, 15-25%, 15-20%, 20-50%, 20-45%, 20-40%, 20-35%, 20-30%, 20-25%, 25-50%, 25-45%, 25-40%, 25-35%, 25-30%, 30-50%, 30-45%, 30-40%, 30-35%, 35-50%, 35-45%, 35-40%, 40-50%, 40-45%, 45-50%, by volume, of the total volume of the nanoparticle structure. For a random packing of homogeneous substantially spherical oxide nanoparticles, the interior pore volume can account for about 30%, by volume, of the total volume of the nanoparticle structure. The interior pore volume can be measured experimentally by measuring how much binder and/or filler is required to completely fill the pores. For example, excess binder, filler, and/or other polymeric material (e.g., polystyrene) can be provided at a known thickness on the second primary surface of a nanoparticle structure and allow the binder, filler, and/or other polymeric material to infiltrate the nanoparticle structure at elevated temperature. The thickness of the binder, filler, and/or other polymeric material layer is measured before and after infiltration to determine the volume of binder, filler, and/or polymeric material layer that has infiltrated the nanoparticle to provide the pore volume. The interior pore volume as a percentage of the total nanoparticle structure volume can then be determined by dividing the pore volume by the total nanoparticle structure volume.

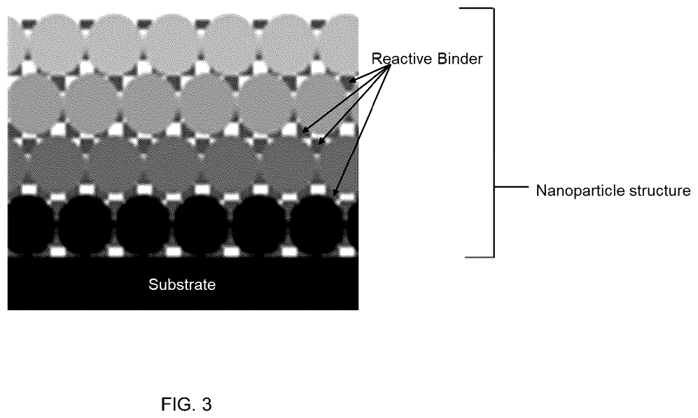

The binder provided in the interior pore volume is covalently bonded to at least a portion of the oxide nanoparticles of the nanoparticle structure. The binder generally has a matrix structure including reacted silicone oligomer, reacted inorganic oxide, or a combination thereof, wherein the reacted silicone oligomer, reacted inorganic oxide, or combination thereof is coupled (e.g., covalently bonded) to other reacted silicone oligomer, other reacted inorganic oxide, and/or an oxide nanoparticle. FIG. 3 shows the placement of the binder in the interior pore volume. However, while FIG. 3 depicts the binder as particles within the interior pore volume, the binder is not discrete particles, but rather a matrix structure provided in the interior pore volume, as described above. The binder can be prepared by reacting silicone oligomer and/or inorganic oxide precursors in the presence of the oxide nanoparticles, to form inorganic networks (i.e., metal or metalloid oxide networks) or organic-inorganic hybrid networks (e.g., silicone oligomer networks). At least a portion of the silicone oligomer and/or inorganic oxide is covalently bound to at least a portion of the oxide nanoparticles. Additional intra-binder bonding (e.g., between silicone oligomers and/or inorganic oxides) provides the matrix structure. In structures that include a substrate, a portion of the binder can be coupled to the substrate. As described in the examples below, the presence of the binder in the nanoparticle structure can provide enhanced mechanical strength (as determined by ASTM D3363-22) to the nanoparticle structure relative to an identical nanoparticle structure that does not include a binder. Structures that include non-reactive compounds (i.e., compounds that cannot form inorganic oxide bonds with the oxide nanoparticles and/or other non-reactive compounds), such as polyperfluoroethylene (PFPE) or polystyrene (PS), do not form a binder having a matrix structure and do not demonstrate the enhanced mechanical strength demonstrated by an oxide nanoparticle structure including a binder of the disclosure.

The reacted inorganic oxide is the reaction product of a metal oxide precursor and/or a metalloid oxide precursor upon curing a composition including the metal oxide precursor and/or metalloid oxide precursor. The inorganic oxide precursor can include one or more of an organic titanate, an organic zirconate, an aluminum alkoxide, a zinc alkoxide, a hafnium alkoxide, an alkali metal silicate, and an organic orthosilicate. The inorganic oxide precursor can include one or more of an organic titanate, an organic titanate, an alkali metal silicate, and an organic orthosilicate. The reacted silicone oligomer is the reaction product of a silicone oligomer upon curing a composition including the silicone oligomer. Suitable commercially available silicone oligomers can include, but are not limited to, Dow Chemical Dowsil™ 2403, Shin-etsu KR 500, and Wacker Chemie SILRES® MSE 100.

The binder is provided in the interior pore volume. The binder can occupy from 10% to 100% of the interior pore volume, such that 0% to 90% of the interior pore volume can remain vacant (i.e., unoccupied pore volume) or can be occupied by a functional filler, as disclosed herein. The amount of binder provided in the interior pore volume can also be characterized as a fill fraction of the pores of the oxide nanoparticle structure. The fill fraction of the binder in the pores of the oxide nanoparticle structure refers to the volume of the pores filled by the binder. Thus, the fill fraction of the binder can be in a range of 10% to 100%. Without intending to be bound by theory, it is believed that as the amount of binder in the pore volume decreases, the improvement to the mechanical strength of the oxide nanoparticle structure decreases and when less than about 10% of the interior pore volume is occupied by the binder, there may be no substantial increase in mechanical strength of the oxide nanoparticle structure relative to an identical oxide nanoparticle structure that does not include a binder.

The binder can occupy from 10% to 100%, by volume, of the interior pore volume (i.e., have a fill fraction from 10% to 100%), for example, at least 10%, 15%, 20%, 25%, 30%, 35%, 40%, 50%, 55%, 60%, 65%, 70%, 75%, 80%, 85%, 90%, 95%, or 100%; alternatively or in addition, the binder can occupy 100%, 95%, 90%, 85%, 80%, 75%, 70%, 65%, 60%, 55%, 50%, 45%, 40%, 35%, 30%, 25%, 20%, 15%, or 10% or less, by volume, of the interior pore volume. For clarity, any two of the foregoing open-ended ranges can be combined to form a closed range. For example, the binder can occupy 10-100%, 10-95%, 10-90%, 10-85%, 10-80%, 10-75%, 10-70%, 10-65%, 10-60%, 10-55%, 10-50%, 10-45%, 10-40%, 10-35%, 10-30%, 10-25%, 10-20%, 10-15%, 15-100%, 15-95%, 15-90%, 15-85%, 15-80%, 15-75%, 15-70%, 15-65%, 15-60%, 15-55%, 15-50%, 15-45%, 15-40%, 15-30%, 15-35%, 15-25%, 15-20%, 20-100%, 20-95%, 20-85%, 20-80%, 20-75%, 20-70%, 20-65%, 20-60%, 20-55%, 20-50%, 20-45%, 20-40%, 20-35%, 20-30%, 20-25%, 25-100%, 25-95%, 25-90%, 25-85%, 25-80%, 25-75%, 25-70%, 25-65%, 25-60%, 25-55%, 25-50%, 25-45%, 25-40%, 25-30%, 30-100%, 30-95%, 30-85%, 30-80%, 30-75%, 30-70%, 30-65%, 30-60%, 30-55%, 30-50%, 30-45%, 30-40%, 30-35%, 35-100%, 35-95%, 35-90%, 35-85%, 35-80%, 35-75%, 35-70%, 35-65%, 35-60%, 35-55%, 35-50%, 35-45%, 35-40%, 40-100%, 40-95%, 40-85%, 40-80%, 40-75%, 40-70%, 40-65%, 40-60%, 40-55%, 40-50%, 40-45%, 45-100%, 45-95%, 45-90%, 45-85%, 45-80%, 45-75%, 45-70%, 45-65%, 45-60%, 45-55%, 45-50%, 50-100%, 50-95%, 50-85%, 50-80%, 50-75%, 50-70%, 50-65%, 50-60%, 50-55%, 55-100%, 55-95%, 55-90%, 55-85%, 55-80%, 55-75%, 55-70%, 55-65%, 55-60%, 60-100%, 60-95%, 60-85%, 60-80%, 60-75%, 60-70%, 60-65%, 65-100%, 65-95%, 65-90%, 65-85%, 65-80%, 65-75%, 65-70%, 70-100%, 70-95%, 70-85%, 70-80%, 70-75%, 75-100%, 75-95%, 75-90%, 75-85%, 75-80%, 80-100%, 80-95%, 80-90%, 80-85%, 85-100%, 85-95%, 85-90%, 90-100%, 90-95%, 95-100% by volume, of the interior pore volume. The fill fraction of the binder can be selected based on the desired properties of the structures of the disclosure. For example, when the oxide nanoparticle structures include a functional filler, the fill fraction of the binder will be less than 100%. As another example, when the oxide nanoparticles structures are used in anti-fog coatings, vacant/void interior pore volume can facilitate water transport through the bulk of the structure and, therefore, the fill fraction of the binder will be less than 100% and in a range of 10% to 90%, 10% to 80%, 10% to 75%, 15% to 65%, or 25% to 50% such that the interior pore volume can accommodate a functional filler while also maintaining void interior pore volume to allow water transport.

The structures of the disclosure including the binder can be characterized by having an unoccupied pore volume (i.e., interior pore volume that remains vacant or that can be occupied by a functional filler) of 0% to 90% of the interior pore volume can remain vacant (i.e., unoccupied pore volume) or can be occupied by a functional filler, as disclosed herein. For example, at least 10%, 20%, 30%, 40%, 50%, 60%, 70%, 80%, or 90%, by volume, of the interior pore volume can remain unoccupied after inclusion of the binder in the nanoparticle structure; alternatively, or additionally, 90%, 80%, 70%, 60%, 50%, 40%, 30%, 20%, 10% or less, by volume, of the interior pore volume can remain unoccupied after inclusion of the binder in the nanoparticle structure. For clarity, any two of the foregoing open-ended ranges can be combined to form a closed range. For example, 0-90%, 0-80%, 0-70%, 0-60%, 0-50%, 0-40%, 0-30%, 0-20%, 0-10%, 10-90%, 10-90%, 10-80%, 10-70%, 10-60%, 10-50%, 10-40%, 10-30%, 10-20%, 20-90%, 20-80%, 20-70%, 20-60%, 20-50%, 20-40%, 20-30%, 30-90%, 30-80%, 30-70%, 30-60%, 30-50%, 30-40%, 40-90%, 40-80%, 40-70%, 40-60%, 40-50%, 50-90%, 50-80%, 50-70%, 50-60%, 60-90%, 60-80%, 60-70%, 70-90%, 70-80%, or 80-90%, by volume, of the interior pore volume can remain unoccupied after inclusion of the binder in the nanoparticle structure.

In some aspects, the nanoparticle structure can be characterized by a volume fraction of nanoparticles of any suitable amount. By depositing the nanoparticle structure using the methods herein, a higher volume fraction of nanoparticles can be achieved as compared with conventional methods. In particular, in conventional methods, where a blend of nanoparticles and a binder are mixed together prior to applying the coating to a surface, there are practical issues that limit high nanoparticle loadings, such as increasing viscosity, agglomeration, and poor dispersion. Specifically, as the nanoparticle fraction is increased, the mixture becomes increasingly viscous and difficult to process; the polymer chains have less mobility, and the risk of particles clustering together rises. This makes it hard to achieve a uniform film when the blend is coated onto a surface. In many practical systems, the loadings are often kept even lower so that the composite remains workable and the desired properties (mechanical, optical, etc.) are not compromised. Such conventional methods can only achieve nanoparticle loadings on the order of up to 40-50 vol. %.

In the methods herein, however, higher nanoparticle loadings can be achieved by first coating, using the methods herein, a densely packed nanoparticle layer on a surface followed by infiltrating the pores/spaces between the nanoparticles with a binder. Such loadings can reach beyond 50 vol. %, typically up to around 74 vol. % of nanoparticles in the nanoparticle structure. For example, in some aspects, the nanoparticle structure can have a volume fraction (vol. %) that can be at least 50, at least 52, at least 54, at least 56, at least 58, at least 60, at least 62, at least 64, at least 64.4, at least 66, at least 68, at least 70, at least 72, at least 73.3, at least 74, 74 or less, 73.3 or less, 72 or less, 70 or less, 68 or less, 66 or less, 64.4 or less, 64 or less, 62 or less, 60 or less, 58 or less, 56 or less, 54 or less, 52 or less, 50 or less, or any range formed from any two of the foregoing endpoints. For example, in some aspects, the volume fraction (vol. %) can be 50-52, 50-54, 50-56, 50-58, 50-60, 50-62, 50-64, 50-64.4, 50-66, 50-68, 50-70, 50-72, 50-73.3, 50-74, 52-54, 52-56, 52-58, 52-60, 52-62, 52-64, 52-64.4, 52-66, 52-68, 52-70, 52-72, 52-73.3, 52-74, 54-56, 54-58, 54-60, 54-62, 54-64, 54-64.4, 54-66, 54-68, 54-70, 54-72, 54-73.3, 54-74, 56-58, 56-60, 56-62, 56-64, 56-64.4, 56-66, 56-68, 56-70, 56-72, 56-73.3, 56-74, 58-60, 58-62, 58-64, 58-64.4, 58-66, 58-68, 58-70, 58-72, 58-73.3, 58-74, 60-62, 60-64, 60-64.4, 60-66, 60-68, 60-70, 60-72, 60-73.3, 60-74, 62-64, 62-64.4, 62-66, 62-68, 62-70, 62-72, 62-73.3, 62-74, 64-64.4, 64-66, 64-68, 64-70, 64-72, 64-73.3, 64-74, 64.4-66, 64.4-68, 64.4-70, 64.4-72, 64.4-73.3, 64.4-74, 66-68, 66-70, 66-72, 66-73.3, 66-74, 68-70, 68-72, 68-73.3, 68-74, 70-72, 70-73.3, 70-74, 72-73.3, 72-74, or 73.3-74. In particular, in some aspects, the volume fraction (vol. %) of nanoparticles in the nanoparticle structure is 55-70, at least 52, 52-74, 64.4-73.3, 62-74, or 66-72.

The volume fraction of nanoparticles can be calculated by any suitable method. For example, refractive indices can be employed. In particular, the refractive index (RI) of a nanoparticle film has a roughly linear relationship with the nanoparticle volume fraction. For example, for nanoparticles consisting of or comprising a significant amount of SiO₂, the calculation is as follows. The RI of SiO₂ is about 1.45, and the RI of air is 1.0. A nanoparticle (NP) film having a volume fraction x will have an RI of 1.45*x+1.00*(1−x). The RI of a pure NP film of SiO₂ is about 1.29-1.33, which calculates x to be a volume fraction of 0.644 to 0.733 (i.e., 64.4-73.3 vol. %). Similar calculations can be employed with the nanoparticles are made of other materials if the RI is known.

The binder can be provided in an amount sufficient to increase the pencil hardness of at least one of the first and second primary surfaces of the oxide nanoparticle structure by at least 1H, at least 2H, at least 3H, at least 4H, at least 5H, at least 6H, at least 7H, or at least 8H, relative to the first or second primary surface of an identical oxide nanoparticle structure that does not include a binder.

At least one of the first and second primary surfaces can have a pencil hardness of at least 2H, 3H, 4H, 5H, 6H, 7H, 8H or 9H; alternatively, or in addition, at least one of the first and second primary surfaces can have a pencil hardness of 9H, 8H, 7H, 6H, 5H, 4H, 3H, or 2H or less, as determined according to ASTM D3363-22. For clarity, any two of the foregoing open-ended ranges can be combined to form a closed range. For example, at least one of the first and second primary surfaces can have a pencil hardness in a range of 2H-9H, 2H-8H, 2H-7H, 2H-6H, 2H-5H, 2H-4H, 2H-3H, 3H-9H, 3H-8H, 3H-7H, 3H-6H, H H-5H, 3H-4H, 4H-9H, 4H-8H, 4H-7H, 4H-6H, 4H-5H, 5H-9H, 5H-8H, 5H-7H, 5H-6H, 6H-9H, 6H-8H, 6H-7H, 7H-9H, 7H-8H, or 8H-9H.

The amount of binder in the interior pore volume can be controlled by controlling the concentration of metal oxide precursor and/or metalloid oxide precursor in a liquid composition used to prepare the structures of the disclosure, according to the methods disclosed herein. The amount of binder in the interior pore volume can be determined by the ratio of nanoparticles and binder, or the refractive index of the nanoparticle structure including the binder. The ratio of nanoparticles and binder can be determined by providing a binder layer on a substrate using the same deposition parameters for depositing the binder on a nanoparticle structure, and the volume of the binder deposited on the substrate can be determined from the thickness of the binder on the substrate. The ratio of binder to nanoparticles can then be determined. The refractive index of the nanoparticle structure including the binder can also be used. The refractive index of the nanoparticle structure at 0% and 100% binder fill can be determined with spectroscopic ellipsometry and intermediate fill fractions can be calculated by determining the refractive index of a partially filled nanoparticle structure and calculating the fill fraction using a simple linear relationship. For example, for a nanoparticle structure having a refractive index at 0% fill of 1.31 and at 100% fill of 1.45, the fill fraction of a nanoparticle structure including binder having a measured index of refraction of 1.38 can be calculated as (1.38-1.31)/(1.45-1.31)=50%.

The structures of the disclosure can further include a functional filler covalently bonded to at least a portion of the oxide nanoparticles, a portion of the binder, or a combination thereof. When the structures include a substrate, a portion of the functional filler can be bonded to a portion of the substrate. The functional filler can generally be any material that, when include in a structure of the disclosure, provides a surface property or bulk property to, or enhances a surface property or bulk property of, a structure, relative to an identical structure that does not include a functional filler. Examples of surface and/or bulk properties imparted to or improved by a functional filler can include, but are not limited to, easy-to-clean surfaces, superhydrophilic surfaces, and bulk water transport. The functional filler can occupy at least 10%, 15%, 20%, 25%, 30%, 35%, 40%, 45%, or 50%, by volume, of the interior pore volume; additionally or alternatively, the functional filler can occupy 50%, 45%, 40%, 35%, 30%, 25%, 20%, 15%, or 10% or less, by volume. For clarity, any two of the foregoing open ended ranges can be combined to form a closed range. For example from 10-50%, 10-45%, 10-40%, 10-35%, 10-30%, 10-25%, 10-20%, 10-15%, 15-50%, 15-45%, 15-40%, 15-35%, 15-30%, 15-25%, 15-20%, 20-50%, 20-45%, 20-40%, 20-35%, 20-30%, 20-25%, 25-50%, 25-45%, 25-40%, 25-35%, 25-30%, 30-50%, 30-45%, 30-40%, 30-35%, 35-50%, 35-45%, 35-40%, 40-50%, 40-45%, 45-50%, by volume, of the interior pore volume.

### Easy-to-Clean Surfaces

The functional filler can include an easy-to-clean (ETC) compound. ETC coatings generally are desirable for cover glass. Because of the daily use of cover glass, the ETC coatings can be damaged and gradually lose the ETC property. The durability of ETC coatings is generally lower on rougher surfaces than on bare glass due to weaker bonding of ETC molecules on rougher surfaces. Oxide nanoparticle structures of the disclosure have intrinsically larger roughness than bare glass. Surfaces rougher than bare glass can be the result of depositing anti-reflective coatings on the glass, prior to depositing an ETC compound, for example. Anti-reflective coatings are well known in the art and can include porous or non-porous metal- or metalloid-oxide coatings.

The ETC compound can generally be any hydrophobic compound that can bond with the oxide nanoparticle structure and optional substrate through a condensation reaction between metal hydroxide or metalloid hydroxide (e.g., silanol) groups of the oxide nanoparticles (and optional substrate) and the ETC compound. The ETC compound can also bond with the binder in the same way. The ETC compound can include a perfluoropolyether silane or polymer thereof, a perfluoroalkyl silane or polymer thereof, an alkyl silane or polymer thereof, a hydroxyl-terminated polydimethylsiloxane, an alkoxy-terminated polydimethylsiloxane, or a combination of any of the foregoing. When the ETC compound is alkoxy-terminated, the terminal alkoxy group can be hydrolyzed to enhance bonding of the ETC and the oxide nanoparticles and/or binder. The perfluoropolyether silane, perfluoroalkyl silane, and/or alkyl silane can have an alkyl chain length of at least 5 carbon atoms, at least 8 carbon atoms, at least 10 carbon atoms, or at least 12 carbon atoms and up to 25 carbon atoms, up to 20 carbon atoms, up to 18 carbon atoms, or up to 15 carbon atoms.

In the structures of the disclosure including an ETC compound as a functional filler, at least one of the first and second primary surfaces can have a water-contact angle (WCA) in a range of 90 degrees to 130 degrees, or about 100 degrees to about 120 degrees, as determined according to ASTM D7490.

The structures of the disclosure including an ETC compound as a functional filler can be prepared to provide robust resistance of the ETC to abrasion. Without intending to be bound by theory, it is believed that because the bonding site for most of the ETC molecules are buried in the nanoparticle stacking, abrasion cannot completely remove the ETC molecules without damaging the whole structure and this “rooting” mechanism results in ETC surfaces that are highly resistant to abrasion. At least one of the first and second primary surfaces of the structures of the disclosure can have a WCA of greater than 90 degrees, greater than 100 degrees, or in a range of 100 degrees to 120 degrees after at least 150,000 abrasion cycles using a cheesecloth with 7.5 N loading. At least one of the first and second primary surfaces of the structures of the disclosure can have a WCA of greater than 100 degrees, greater than 105 degrees, greater than 110 degrees, or in a range of 100 degrees to 120 degrees after at least 200,000 abrasion cycles using a cheesecloth with 7.5 N loading.

In the structures of the disclosure including an ETC compound as a functional filler, 0% to 30%, by volume, of the interior pore volume is unoccupied (i.e., vacant pore volume not filled with a binder or functional filler), for example, 0% to 25%, 0% to 20%, 0% to 15%, 0% to 10%, or 0% to 5%, by volume, of the interior pore volume is unoccupied.

### Superhydrophilic Surfaces

The functional filler can include a hydrophilic compound. The hydrophilic compound can impart superhydrophilicity to a nanoparticle structure or surface thereof. Superhydrophilicity is a desired surface property, especially for glass products, as anti-fogging coatings. A superhydrophilic surface can completely disperse a water droplet. Practically, a superhydrophilic surface has a low water-contact angle, for example, less than 15 degrees, less than 10 degrees, or in a range of 0 degrees to 10 degrees. Nanoparticle films, such as TiO₂ and SiO₂, have been used as materials for superhydrophilic coatings. However, the lifetime of the superhydrophilicity of the nanoparticle coatings is relatively short. For example, the superhydrophilic lifetime of a commercial nano-TiO₂ coating in darkness is only a few weeks. While the hydrophilicity of TiO₂ can be maintained with UV light, the nanoporous structure makes the nanoparticle coatings very susceptible to adsorbing materials from the environment, which can cover the nanoparticle surface, resulting in the surface losing superhydrophilicity.

The hydrophilic compound can generally be any hydrophilic compound that can bond with the oxide nanoparticle structure and optional substrate through a condensation between metal hydroxide or metalloid hydroxide (e.g., silanol) groups of the oxide nanoparticles (and optional substrate) and the hydrophilic compound. The hydrophilic compound can also bond with the binder in the same way. The hydrophilic compound can include an ionic hydrophilic silane, a neutral hydrophilic silane, a polymer of the foregoing, or any combination of the foregoing. Suitable ionic hydrophilic silanes include, but are not limited, to zwitterionic silanes such as 3-{[dimethyl (3-trimethoxysilyl) propyl]ammonio}propane-1-sulfonate. Suitable neutral hydrophilic silanes include, but are not limited to, polyethylene glycol-containing silanes such as trimethoxysilylpropoxypolyethyleneoxide methyl ether. When the hydrophilic compound alkoxy-silyl groups, the alkoxy group can be hydrolyzed to enhance bonding of the hydrophilic compound and the oxide nanoparticles and/or binder.

In structures of the disclosure including a hydrophilic compound as a functional filler, at least one of the first and second primary surfaces can have a water-contact angle (WCA) in a range of 0 degrees to 15 degrees, 0 degrees to 12 degrees, 0 degrees to 11 degrees, 0 degrees to 10 degrees, 0 degrees to 9 degrees, 0 degrees to 7 degrees, 0 degrees to 5 degrees, or 0 degrees to 3 degrees as determined according to ASTM D7490. In structures of the disclosure including a hydrophilic compound as a functional filler, at least one of the first and second primary surfaces can have a water-contact angle (WCA) in a range of 0 degrees to 20 degrees, as determined according to ASTM D7490, for a lifetime (i.e., after storage at ambient conditions) for at least 7, 10, 15, 20, 25, 30, 35, or 40 weeks; alternatively or additionally, for a lifetime of 40, 35, 30, 25, 20, 15, 10, or 7 weeks or less. For clarity, any two of the foregoing open-ended ranges can be combined to form a closed range. For example, at least one of the first and second primary surfaces of the structures of the disclosure including a hydrophilic compound as a functional filler can have a WCA in a range of 0 to 20 degrees for a lifetime of 7-40, 7-35, 7-30, 7-25, 7-20, 7-15, 7-10, 10-40, 10-35, 10-30, 10-25, 10-20, 10-15, 15-40, 15-35, 15-30, 15-25, 15-20, 20-40, 20-35, 20-30, 20-25, 25-40, 25-35, 25-30, 30-40, 30-35, or 35-40 weeks.

The structures of the disclosure including a hydrophilic compound as a functional filler can demonstrate improved hydrophilicity relative to an identical structure not including a hydrophilic compound as a functional filler. Without intending to be bound by theory, it is believed that structures not including a hydrophilic compound are more easily contaminated resulting in a rapid decrease in hydrophilicity over the lifetime of the structure due to larger interior pore volumes (not occupied with binder and/or filler) that can accommodate contaminants and decrease surface energy.

In the structures of the disclosure including hydrophilic compound as a functional filler, 20% to 40%, by volume, of the interior pore volume is unoccupied (i.e., vacant pore volume not filled with a binder or functional filler), for example, 20% to 35%, 20% to 30%, or 20% to 25%, by volume, of the interior pore volume is unoccupied.

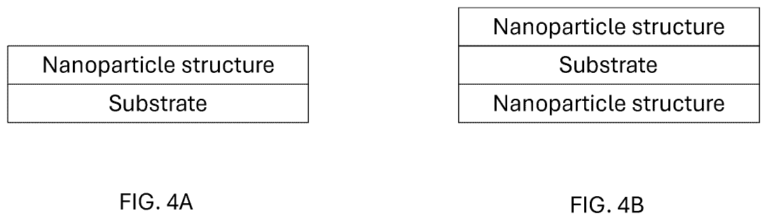

Structures of the disclosure can further include a substrate. The nanoparticle structure can be provided on at least one surface of the substrate. As shown in FIG. 4A, the nanoparticle structure can be provided on one surface of a substrate. As shown in FIG. 4B, the nanoparticle structure can be provided on two surfaces of a substrate. The first primary surface of the nanoparticle structure can be provided on a surface of the substrate. The substrate is not particularly limited and can include glass, glass-ceramic, polymer, or any combination thereof. The surface of the substrate can include hydroxyl groups.

The structures of the disclosure can be transparent. The structures of the disclosure can have an average transmittance of at least 90%, at least 92%, at least 95%, at least 98%, at least 99%, or at least 100% transmittance of visible light having a wavelength in a range of 380 nm to 600 nm. The structures of the disclosure can be used as Bragg reflectors (also referred to as Bragg mirrors), antireflective coatings, high reflective coatings, or beam splitters. The structures of the disclosure can be antireflective.

The disclosure further comprises a consumer electronic product including a housing having a front surface, a back surface and side surfaces; electrical components provided at least partially within the housing, the electrical components including at least a controller, a memory, and a display, the display being provided at or adjacent to the front surface of the housing, optionally, at least one of a lens and a sensor, each configured at least partially within the housing; and a cover substrate disposed over at least one of the display, the lens, and the sensor; wherein at least a portion of at least one of the housing and the cover substrate include a structure of the disclosure.

The disclosure further comprises methods of preparing structures of the disclosure, the methods including (i) depositing a nanoparticle structure on a substrate, wherein the nanoparticle structure comprises a first primary surface and a second primary surface opposite the first primary surface, the first primary surface being proximal to the substrate; one or more layers of oxide nanoparticles disposed between and constituting the first and second primary surfaces; and an interior pore volume located in spaces between oxide nanoparticles; (ii) infiltrating the interior pore volume with a reactive binder, and optionally (iii) removing the nanoparticle structure from the substrate.

The methods of the disclosure can further comprise (iv) infiltrating the interior pore volume with a functional filler and providing a layer of functional filler on the second primary surface of the nanoparticle structure.

Depositing the nanoparticle structure can include depositing one or more compositions comprising oxide nanoparticles on the substrate. The oxide nanoparticles can be any of the oxide nanoparticles disclosed herein. The oxide nanoparticles can be deposited on the substrate by spin-coating, dip-coating, spray-coating, bar-coating, screen-coating, slot-die coating, blade-coating, inkjet printing, or any combination thereof. The nanoparticles can be deposited on the substrate by spin-coating, dip-coating, spray-coating, or any combination thereof. The oxide nanoparticles can be deposited as a liquid composition, e.g., a suspension or mixture, including a liquid carrier and the oxide nanoparticles. The liquid carrier can generally comprises a liquid that can disperse the oxide nanoparticles. The liquid carrier can be selected based on the surface chemistry of the nanoparticles. Hydrophilic nanoparticles, for example, oxide nanoparticles that do not include surface modifications, can be dispersed in liquids including, but not limited to, water, methanol, ethanol, isopropanol, combinations thereof, and the like. Hydrophobic nanoparticles, for example, oxide nanoparticles having hydrophobic surface modifications, can be dispersed in liquids including, but not limited to, propylene glycol methyl ether acetate (PGMEA), xylene, toluene, combinations thereof, and the like. The concentration of nanoparticles in the liquid composition is not particularly limited. The nanoparticles can be provided in the liquid composition in an amount in a range of 0.1 wt. % to 50 wt. %, based on the total weight of the liquid composition, for example, 0.5 wt. % to 40 wt. %, 1 wt. % to 30 wt. %, 2 wt. % to 25 wt. %, 3 wt. % to 20 wt. %, 4 wt. % to 15 wt. %, or 5 wt. % to 10 wt. %. As described herein, the packing density of the nanoparticles in the nanoparticle structure and resulting interior pore volume are properties of the selection of oxide nanoparticle. The packing density of the nanoparticles in the nanoparticle structure is not dependent on the concentration of the nanoparticles in the liquid composition, provided that the concentration of nanoparticles in the liquid composition is not so low as to prevent a single layer of nanoparticles from forming.

As used herein, “depositing one or more compositions comprising oxide nanoparticles on the substrate” encompasses depositing a first composition comprising oxide nanoparticles on the substrate to form a layer of nanoparticle structure and depositing further compositions comprising oxide nanoparticles on the layer of nanoparticle structure (and/or subsequent layers of nanoparticle structure) to form additional layers of nanoparticle structure. In methods wherein multiple compositions comprising oxide nanoparticles are deposited, between the deposition of each composition comprising oxide nanoparticles, the nanoparticle structure can be cleaned with air plasma treatment or oxygen plasma treatment. The term “nanoparticle structure” used herein refers to the totality of the layers of nanoparticle structure deposited, whether one layer or multiple layers. Further, it will be understood that a layer of nanoparticle structure encompasses a monolayer of oxide nanoparticles as well as multiple layers of oxide nanoparticles. The nanoparticle structure can be deposited as one or more layers to achieve any desired thickness disclosed herein, for example, a thickness in a range of 5 nm to 5000 nm.

The methods of the disclosure can further comprise drying the nanoparticle structure after depositing of the nanoparticle structure and prior to infiltrating the interior pore volume with a reactive binder.

The reactive binder can be any one or more of the silicone oligomer, metal oxide precursor, or metalloid oxide precursor disclosed herein that can be cured to form the binder, as disclosed herein. Infiltrating the interior pore volume with a reactive binder can include depositing a reactive binder solution on the nanoparticle structure and allowing the binder solution to infiltrate into the interior pore volume of the nanoparticle structure.

The reactive binder can be deposited by spin-coating, dip-coating, spray-coating, bar-coating, screen-coating, slot-die coating, blade-coating, inkjet printing, or any combination thereof. The reactive binder can be deposited by spin-coating, dip-coating, spray-coating, or any combination thereof. The reactive binder can be deposited neat. The reactive binder can be deposited as a solution of a solvent and the reactive binder. The solvent can comprise any solvent that can dissolve the reactive binder. Suitable solvents include, but are not limited to, water, methanol, ethanol, isopropanol, propylene glycol methyl ether acetate (PGMEA), xylene, toluene, and combinations thereof. The concentration of the reactive binder in the solution can be selected to control the amount of binder provided in the interior pore volume of the nanoparticle structure. In general, as the concentration of reactive binder in the solution increases, the amount of binder provided in the interior pore volume of the nanoparticle structure increases. The reactive binder can be provided in the solution in an amount in a range of 0.1% to 50%, by weight, based on the total weight of the solution, for example 0.5% to 40%, 1% to 30%, 2% to 25%, 4% to 20%, 5% to 15%, or 8% to 12%, by weight, based on the total weight of the solution.

The reactive binder can generally infiltrate the nanoparticle structure in the time required to deposit the reactive binder and evaporate the solvents. Thus, the reactive binder can be allowed to infiltrate the nanoparticle structure for a time in a range of 1 second to 24 hours, 5 seconds to 18 hours, 10 seconds to 12 hours, 15 seconds to 6 hours, 30 seconds to 3 hours, 45 seconds to 1 hour, 1 minute to 30 minutes, 1 minute to 15 minutes, 1 minute to 10 minutes, or 1 minute to 5 minutes. When the reactive binder is a liquid at ambient conditions, the reactive binder can readily infiltrate and equilibrate into the interior pore volume of the nanoparticle structure, for example, in less than 1 minute.

The solution of reactive binder can optionally further include a curing catalyst. When the solution of reactive binder includes a curing catalyst the curing catalyst can be provided in an amount of about 0.1% to about 5%, by weight, relative to the weight of the reactive binder, for example 0.5% to 4%, 1% to 3%, or 2%, by weight, relative to the weight of the reactive binder. Suitable curing catalysts can include, but are not limited to, tetrabutyl titanate, stannous octoate, dibutyltin dilaurate, dibutyltin diacetate, dibutyl tin oxide; tin oxide, tetraethylhexyl titanate, tetraphenyltitanate, or a combination thereof. Curing catalysts can be included in the solution to facilitate curing, e.g., at lower temperatures and/or for shorter times, than would otherwise be required to cure the reactive binder in the absence of a catalyst.

The reactive binder can be cured to form the binder in the interior pore volume of the nanoparticle structure as disclosed herein. The reactive binder can generally be cured at a temperature in a range of 20° C. to 400° C., for example, 50° C. to 350° C., 100° C. to 300° C. 150° C. to 250° C., or 200° C. for a time in a range of 5 minutes to 2 weeks, 30 minutes to 1 week, 1 hour to 3 days, 3 hours to 24 hours, 6 hours to 20 hours, 8 hours to 16 hours, or 10 hours to 14 hours. In general, as the curing temperature increases, the time required to completely cure the reactive binder decreases. The reactive binder can be cured prior to infiltrating the interior pore volume with a functional filler and providing a layer of functional filler on the second primary surface of the nanoparticle structure.

The functional filler can be any one or more of the functional fillers disclosed herein that can provide a surface property or bulk property to, or enhance a surface property or bulk property of, a structure, relative to an identical structure that does not include the functional filler. Infiltrating the interior pore volume with a functional filler and providing a layer of functional filler on the second primary surface can include depositing a functional filler solution on the nanoparticle structure and allowing at least a portion of the functional filler solution to infiltrate into the interior pore volume of the nanoparticle structure.

The functional filler can be deposited by spin-coating, dip-coating, spray-coating, bar-coating, screen-coating, slot-die coating, blade-coating, inkjet printing, or any combination thereof. The functional filler can be deposited by spin-coating, dip-coating, spray-coating, or any combination thereof. The functional filler can be deposited neat. The functional filler can be deposited as a solution of a solvent and the functional filler. The solvent can comprise any solvent that can dissolve the functional filler. Suitable solvents include, but are not limited to, water, methanol, ethanol, isopropanol, propylene glycol methyl ether acetate (PGMEA), xylene, toluene, and combinations thereof. The concentration of the functional filler in the solution can be selected to control the amount of functional filler provided in the interior pore volume and on the second primary surface of the nanoparticle structure. In general, as the concentration of functional filler in the solution increases, the amount of functional filler provided in the interior pore volume and on the second primary surface of the nanoparticle structure increases. The functional filler can be provided in the solution in an amount in a range 0.1% to about 5%, by weight, relative to the weight of the reactive binder, for example 0.5% to 4%, 1% to 3%, or 2%, by weight, relative to the weight of the reactive binder.

The functional filler can generally infiltrate the nanoparticle structure in the time required to deposit the functional filler and evaporate the solvents. Thus, the reactive binder can be allowed to infiltrate the nanoparticle structure for a time in a range of 1 seconds to 24 hours, 5 seconds to 18 hours, 10 seconds to 12 hours, 15 seconds to 6 hours, 30 seconds to 3 hours, 45 seconds to 1 hour, 1 minute to 30 minutes, 1 minute to 15 minutes, 1 minute to 10 minutes, or 1 minute to 5 minutes. When the functional filler is a liquid at ambient conditions, the functional filler can readily infiltrate and equilibrate into the interior pore volume of the nanoparticle structure, for example, in less than 1 minute.

The solution of functional filler can optionally further include a curing catalyst. When the solution of functional filler includes a curing catalyst the curing catalyst can be provided in an amount of about 0.1% to about 5%, by weight, relative to the weight of the reactive binder, for example 0.5% to 4%, 1% to 3%, or 2%, by weight, relative to the weight of the reactive functional filler. Suitable curing catalysts can include, but are not limited to, tetrabutyl titanate, stannous octoate, dibutyltin dilaurate, dibutyltin diacetate, dibutyl tin oxide; tin oxide, tetraethylhexyl titanate, tetraphenyltitanate, or a combination thereof. Curing catalysts can be included in the solution to facilitate curing, e.g., at lower temperatures and/or for shorter times, than would otherwise be required to cure the functional filler in the absence of a catalyst.

The functional filler can generally be cured at a temperature in a range of 20° C. to 400° C., for example, 50° C. to 350° C., 100° C. to 300° C. 150° C. to 250° C., or 200° C. for a time in a range of 5 minutes to 2 weeks, 30 minutes to 1 week, 1 hour to 3 days, 3 hours to 24 hours, 6 hours to 20 hours, 8 hours to 16 hours, or 10 hours to 14 hours. In general, as the curing temperature increases, the time required to completely cure the functional filler decreases.

The methods of the disclosure can further include pre-treating (also called conditioning) the structure, after deposition of the functional filler and before curing of the functional filler. The pre-treatment can promote enhanced bonding of the functional filler and the nanoparticle structure. Without intending to be bound by theory, it is believed that the pre-treatment can enhance bonding of the functional filler and the nanoparticle structure in two ways; first, by hydrolyzing at least a portion of any alkoxy groups on the functional filler to improve the affinity of the functional filler for the nanoparticle surface and, second, by relaxing any long chains in the functional filler that may otherwise block reaction sites. Pre-treatment can include conditioning under ambient conditions for a time in a range of 10 minutes to 2 weeks, 30 minutes to 12 days, 1 hour to 10 days, 6 hours to 8 days, 12 hours to 7 days, 24 hours to 6 days, or 2 days to 4 days. Pre-treatment can include conditioning at high temperature conditions, for example, at a temperature of at least 60° C., 65° C., 70° C., 75° C., 80° C., 85° C., 90° C., 95° C., or 100° C.; alternatively, or additionally, the temperature can be 100° C., 95° C., 90° C., 85° C., 80° C., 75° C., 70° C., 65° C., or 60° C. or less. For clarity, any two of the foregoing open-ended ranges can be combined to form a closed range. For example, the temperature can be 60° C. to 100° C., 60° C. to 95° C., 60° C. to 90° C., 60° C. to 85° C., 60° C. to 80° C., 60° C. to 75° C., 60° C. to 70° C., 60° C. to 65° C., 65° C. to 100° C., 65° C. to 95° C., 65° C. to 90° C., 65° C. to 85° C., 65° C. to 80° C., 65° C. to 75° C., 65° C. to 70° C., 70° C. to 100° C., 70° C. to 95° C., 70° C. to 90° C., 70° C. to 85° C., 70° C. to 80° C., 70° C. to 75° C., 75° C. to 100° C., 75° C. to 95° C., 75° C. to 90° C., 75° C. to 85° C., 75° C. to 80° C., 80° C. to 100° C., 80° C. to 95° C., 80° C. to 90° C., 80° C. to 85° C., 85° C. to 100° C., 85° C. to 95° C., 85° C. to 90° C., 90° C. to 100° C., 90° C. to 95° C., or 95° C. to 100° C. Pre-treatment can include conditioning at high humidity conditions, for example, a relative humidity (RH) of at least 60%, 65%, 70%, 75%, 80%, 85%, 90%, 95%, or 100%; alternatively, or additionally, the relative humidity can be 100%, 95%, 90%, 85%, 80%, 75%, 70%, 65%, or 60% or less. For clarity, any two of the foregoing open-ended ranges can be combined to form a closed range. For example, the relative humidity can be in a range of 60% to 100%, 60% to 95%, 60% to 90%, 60% to 85%, 60% to 80%, 60% to 75%, 60% to 70%, 60% to 65%, 65% to 100%, 65% to 95%, 65% to 90%, 65% to 85%, 65% to 80%, 65% to 75%, 65% to 70%, 70% to 100%, 70% to 95%, 70% to 90%, 70% to 85%, 70% to 80%, 70% to 75%, 75% to 100%, 75% to 95%, 75% to 90%, 75% to 85%, 75% to 80%, 80% to 100%, 80% to 95%, 80% to 90%, 80% to 85%, 85% to 100%, 85% to 95%, 85% to 90%, 90% to 100%, 90% to 95%, or 95% to 100%. Pre-treatment can include conditioning at high temperature and high humidity conditions for a time of at least 12, 16, 18, 20, 22, or 24 hours; alternatively, or additionally the time can be 24, 22, 20, 18, 16, or 12 hours or less. For clarity, any two of the foregoing open-ended ranges can be combined to form a closed range. For example, the time can be in a range of 12 to 24 hours, 12 to 22 hours, 12 to 20 hours, 12 to 18 hours, 12 to 16 hours, 16 to 24 hours, 16 to 22 hours, 16 to 20 hours, 16 to 18 hours, 18 to 24 hours, 18 to 22 hours, 18 to 20 hours, 20 to 24 hours, 20 to 22 hours, or 22 to 24 hours.

The methods of the disclosure can further include treating the structure with an air plasma treatment or an oxygen plasma treatment after curing the functional filler to activate the surface.

Various aspects of the disclosure are described below.

Aspect 1. A structure, comprising a nanoparticle structure including a first primary surface and a second primary surface opposite the first primary surface; one or more layers of oxide nanoparticles disposed between and constituting the first and second primary surfaces; an interior pore volume located in spaces between oxide nanoparticles; and a binder provided in the interior pore volume and covalently bonded to at least a portion of the oxide nanoparticles.

Aspect 2. The structure of Aspect 1, wherein the oxide nanoparticles comprise SiO2, ZrO2, TiO2, Al2O3, MgO, HfO2, ZnO or any combination thereof.

Aspect 3. The structure of any one of the preceding Aspects, wherein the oxide nanoparticles in each layer independently are substantially the same.

Aspect 4. The structure of any one of the preceding Aspects, wherein the nanoparticle structure comprises two or more layers of oxide nanoparticles.

Aspect 5. The structure of Aspect 4, wherein the oxide nanoparticles of the two or more layers of oxide nanoparticles are substantially the same.

Aspect 6. The structure of any one of Aspects 1 to 4, wherein the structure comprises a first layer of oxide nanoparticles and a second layer of oxide nanoparticles, wherein the oxide nanoparticles in the first layer are substantially the same and the oxide nanoparticles in the second layer are substantially the same but different from the oxide nanoparticles in the first layer.

Aspect 7. The structure of Aspect 6, wherein the nanoparticle structure comprises alternating layers of the first layer of oxide nanoparticles and the second layer of oxide nanoparticles.

Aspect 8. The structure of any one of the preceding Aspects, wherein the oxide nanoparticles have an average particle size in a range of 5 nm to 500 nm.

Aspect 9. The structure of any one of the preceding Aspects, wherein the nanoparticle structure has a thickness in a range of 5 nm to 5000 nm.

Aspect 10. The structure of any one of the preceding Aspects, wherein the interior pore volume accounts for 10% to 50%, by volume, of a total volume of the nanoparticle structure.

Aspect 11. The structure of any one of the preceding Aspects, wherein the binder comprises a matrix structure comprising reacted silicone oligomer, reacted inorganic oxide, or a combination thereof.

Aspect 12. The structure of any one of the preceding Aspects, wherein 10% to 100%, by volume, of the interior pore volume is occupied by the binder.

Aspect 13. The structure of any one of the preceding Aspects, further comprising a functional filler covalently bonded to at least a portion of the oxide nanoparticles, at least a portion of the binder, or both.

Aspect 14. The structure of Aspect 13, wherein the functional filler comprises an easy-to-clean (ETC) compound or a hydrophilic compound.

Aspect 15. The structure of Aspect 14, wherein the ETC comprises a perfluoropolyether silane or polymer thereof, a perfluoroalkyl silane or polymer thereof, an alkyl silane or polymer thereof, a hydroxyl-terminated polydimethylsiloxane, an alkoxy-terminated polydimethylsiloxane, or any combination thereof.

Aspect 16. The structure of Aspect 14, wherein the hydrophilic compound comprises an ionic hydrophilic silane, a neutral hydrophilic silane, a polymer thereof, or any combination thereof.

Aspect 17. The structure of any one of Aspects 13 to 16, wherein 10% to 50%, by volume, of the interior pore volume is occupied by the functional filler.

Aspect 18. The structure of any one of the preceding Aspects, wherein the structure further comprises a substrate and the nanoparticle structure is provided on at least one surface of the substrate.

Aspect 19. The structure of Aspect 18, wherein the substrate comprises glass, glass-ceramic, polymer, or any combination thereof.

Aspect 20. The structure of any one of the preceding Aspects, wherein 0% to 90%, by volume, of the interior pore volume is unoccupied.

Aspect 21. The structure of any one of the preceding Aspects, wherein at least one of the first and second primary surfaces has a pencil hardness in a range of 2H to 9H.

Aspect 22. The structure of any one of the preceding Aspects, wherein at least one of the first and second primary surfaces has a water contact angle (WCA) and the WCA is in a range of 0 degrees to 15 degrees.

Aspect 23. The structure of any one of the preceding Aspects, wherein the WCA is in a range of 0 degrees to 20 degrees after storage at ambient conditions for 40 weeks.

Aspect 24. The structure of any one of Aspects 1 to 21, wherein at least one of the first and second primary surfaces has a WCA and the WCA is in a range of 90 degrees to 130 degrees.

Aspect 25. The structure of Aspect 24, wherein at least one of the first and second primary surfaces has a WCA of greater than 90 after at least 150,000 abrasion cycles.

Aspect 26. The structure according to any one of the preceding Aspects, wherein the structure is transparent.

Aspect 27. The structure according to any one of the preceding Aspects, wherein the structure is antireflective.

Aspect 28. A consumer electronic product, comprising: a housing having a front surface, a back surface and side surfaces; electrical components provided at least partially within the housing, the electrical components including at least a controller, a memory, and a display, the display being provided at or adjacent to the front surface of the housing; optionally, at least one of a lens and a sensor, each configured at least partially within the housing; and a cover substrate disposed over at least one of the display, the lens, and the sensor; wherein at least a portion of at least one of the housing and the cover substrate comprises the structure of any one of Aspects 1 to 27.

Aspect 29. A method of preparing a structure, the method comprising: (i) depositing a nanoparticle structure on a substrate, wherein the nanoparticle structure comprises: a first primary surface and a second primary surface opposite the first primary surface, the first primary surface being proximal to the substrate; one or more layers of oxide nanoparticles disposed between and constituting the first and second primary surfaces; and an interior pore volume located in spaces between oxide nanoparticles; (ii) infiltrating the interior pore volume with a reactive binder; and optionally (iii) removing the nanoparticle structure from the substrate.

Aspect 30. The method of Aspect 29, wherein the method further comprises: (iv) infiltrating the interior pore volume with a functional filler and providing a layer of functional filler on the second primary surface of the nanoparticle structure.

Aspect 31. The method of Aspect 29 or claim 30, wherein the depositing comprises depositing one or more compositions comprising oxide nanoparticles on the substrate.

Aspect 32. The method of any one of Aspects 29 to 31, wherein the one or more compositions comprising oxide nanoparticles, the reactive binder, and the functional filler are independently deposited by spin-coating, dip-coating, spray-coating, bar-coating, screen-coating, slot-die coating, blade-coating, inkjet printing, or any combination thereof.

Aspect 33. The method of any one of Aspects 29 to 32, further comprising drying the nanoparticle structure.

Aspect 34. The method of any one of Aspects 29 to 33, further comprising curing the reactive binder at a temperature in a range of 20° C. to 400° C. for a time in a range of 5 minutes to 2 weeks.

Aspect 35. The method of any one of Aspects 30 to 34, further comprising curing the functional filler at a temperature in a range of 20° C. to 400° C. for a time in a range of 5 minutes to two weeks.

Aspect 36. The method of Aspect 35, further comprising conditioning the structure at ambient conditions for a time in a range of 10 minutes to 2 weeks or conditioning the structure at a temperature in a range of 60° C. to 100° C. and a humidity of 60% to 100% relative humidity for a time in a range of 12 hours to 24 hours prior to curing the functional filler.

Aspect 37. The method of Aspect 35 or claim 36, further comprising treating the structure with an air plasma treatment or an oxygen plasma treatment after curing the functional filler.

### EXAMPLES

The following examples are set forth so as to provide those of ordinary skill in the art with a complete disclosure and description of how the materials, structures, and methods described and claimed herein are made and evaluated and are intended to be purely exemplary and are not intended to limit the scope of the description. Unless indicated otherwise, parts are parts by weight, temperature is in ° C. or is at ambient temperature, and pressure is at or near atmospheric pressure. There are numerous variations and combinations of reaction conditions, e.g., component concentrations, desired solvents, solvent mixtures, temperatures, pressure and other reaction ranges and conditions that maybe used to optimize the product obtained from the described process. Only reasonable and routine experimentation will be required to optimize such process conditions.

### Example 1—Preparation of Nanoparticle Structures

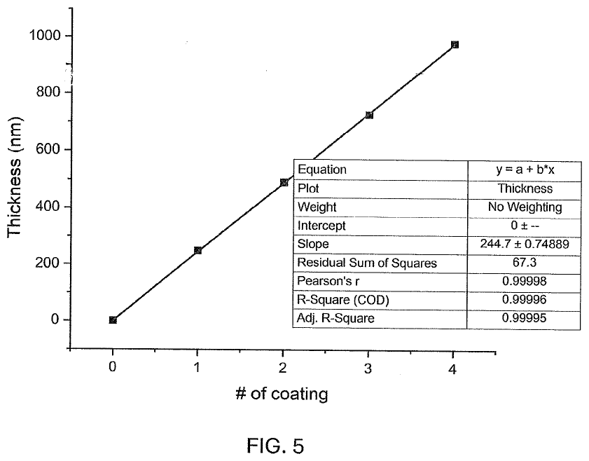

To obtain highly controlled optical properties, multiple layers of different oxide nanoparticles (NPs) can be used. SiO₂, TiO₂, and ZrO₂ NPs were used to prepare various oxide nanoparticle structures. The average NP diameter for the NPs used in this example was around 20 nm. The NP structures were prepared by spin coating suspensions of NPs on either bare Si/glass or on previous coatings of NPs. The thickness of each NP coating was measured with spectroscopic ellipsometry to check the thickness of NP coatings on different substrates/NPs. FIG. 5 shows the total thickness of a structure prepared from SiO₂ NPs, including 4 consecutive coatings using the same parameters. In particular, each coating was prepared from an 8 wt. % nanoparticle suspension in isopropanol spin coated at 2000 rpm for 30 seconds. The substantially perfect linearity indicates good consistency of the NP coatings. To further check the coating consistency, different stackings of NPs were prepared. Two characteristic NP stackings on Si wafer with native oxide layer were prepared. The first was a TiO₂—SiO₂—TiO₂—SiO₂ stacking and the second was a TiO₂—SiO₂—ZrO₂—SiO₂ stacking. The orders are based on coating preparation, from bottom to top on the sample. Cauchy model was used for the refractive indices:

$$n = A + \frac{B}{λ} + \frac{C}{{λ}^{2}} ,$$

where C was set to 0 to reduce the number of fitting parameters because of the limited wavelength range of the ellipsometer without interfering the fitting quality.

An ellipsometry model was obtained for the structure including the TiO₂—SiO₂—TiO₂—SiO₂ stacking:

Layer 5: SiO₂ Coupled; Thickness = 172.45 nm (fit);
Coupled to Layer 3 (Cauchy)
Layer 4: TiO₂ Coupled; Thickness = 54.60 nm (fit);
Coupled to Layer 2 (Cauchy)
Layer 3: SiO₂ Cauchy; Thickness = 169.77 nm (fit); A =
1.317 (fit); B = 0.00347 (fit); C = 0.000
Layer 2: TiO₂ Cauchy; Thickness = 56.61 nm (fit); A =
1.674 (fit); B = 0.03475 (fit); C = 0.000
Layer 1: Native oxide 1.00 nm
Substrate

The layers of the same NPs were prepared with the same suspension and spin parameters. In particular, an 8 wt. % suspension of SiO₂ nanoparticles in isopropanol was spin coated at 4000 rpm for 30 seconds and an 8 wt. % suspension of TiO₂ nanoparticles in PGMEA was spin coated at 6000 rpm for 30 seconds. Coupled refractive indices (same parameters for layer 2 and layer 4, and layer 3 and layer 5) were used for the layers with the same NPs to get good fitting with fewer fitting parameters, which indicated the same NP packing density in each layer. With the coupled refractive indices, the thickness of layers with the same NPs had error less than 3 nm.

An ellipsometry model was obtained for the structure including the TiO₂—SiO₂—ZrO₂—SiO₂ stacking:

Layer 5: SiO₂ Cauchy; Thickness = 168.25 nm (fit); A = 1.318 (fit);
B = 0.00289 (fit); C = 0.000
Layer 4: ZrO₂ Cauchy; Thickness = 82.71 nm (fit); A = 1.593 (fit);
B = 0.00166 (fit) C = 0.000
Layer 3: SiO₂ Cauchy; Thickness = 163.69 nm (fit); A = 1.380 (fit);
B = 0.00370 (fit); C = 0.000
Layer 2: TiO₂ Cauchy; Thickness = 56.48 nm (fit); A = 1.693 (fit);
B = 0.04611 (fit); C = 0.000
Layer 1: Native oxide 1.00 nm
Substrate

The same TiO₂ and SiO₂ coating parameters were applied to this sample as for the sample with the TiO₂—SiO₂—TiO₂—SiO₂ stacking. A 10 wt. % suspension of ZrO₂ nanoparticles in water was spin coated at 2000 rpm for 30 seconds. The thickness of the TiO₂ and SiO₂ layers matched well with the results in the TiO₂—SiO₂—TiO₂—SiO₂ stacking. However, with the ZrO₂ on the top, the refractive indices of the bottom TiO₂ and SiO₂ layers increased. This was attributed to the infiltration of the dispersing agents in the ZrO₂ NP suspension into the bottom layers. The top SiO₂ layer had the same thickness and refractive index as the sample in the TiO₂—SiO₂—TiO₂—SiO₂ stacking, within error. The results together confirmed the good coating quality and consistency of the different NPs on different underlayers used, which can enable the design and fabrication of more complicated optical coatings.

The oxide nanoparticle structures prepared had a random packing of nanoparticles having an interior pore volume of around 30%. The mean pore diameter was about 30% of the nanoparticle diameter, about 6 nm.

Thus, Example 1 demonstrates preparation of oxide nanoparticle structures of the disclosure.

### Example 2—Preparation of Nanoparticle Structures with Binder

Due to the weak interactions between oxide nanoparticles, nanoparticle structures can demonstrate poor mechanical properties and can easily be damaged. Reactive oligomer binders were introduced to enhance the mechanical properties of the oxide nanoparticle structures.

SiO₂ nanoparticle structures having thicknesses of about 500 nm were prepared on a Si/glass substrate in the same way as the nanoparticle structures prepared in Example 1. The nanoparticle structures each had a first primary surface in contact with the substrate and a second primary surface opposite the first primary surface. The nanoparticle structures had an interior pore volume of about 30%.

Three different methyl functionalized silicon oligomers, Dow Chemical Dowsil™ 2403 (noted as 2403), Shin-etsu KR 500 (noted as KR 500), and Wacker Chemie SILRES® MSE 100 (noted as MSE 100), were tested as reactive binders. Solutions of silicon oligomers were prepared by dissolving the silicon oligomers in ethanol (EtOH) at concentrations of 3%, 5%, 8%, and 10%, by weight, based on the total weight of the solution. The solutions further included 5% tetrabutyl titanate (TnBt), relative to the mass of the silicon oligomers, as a curing catalyst. The solutions were spin coated on the nanoparticle structures. Because the silicone oligomers are liquid at room temperature, they were able to infiltrate into the interior pore volume of the nanoparticle structures and equilibrate in less than 1 min. The silicon oligomers were cured at 200° C. for about 16 hours to form the binder in the interior pore volume of the nanoparticle structures.

After curing, the pencil hardness of the second primary surface of the nanoparticle structures including the binder was determined according to ASTM D3363-22. For comparison, the pencil hardness of an identical nanoparticle structure that is otherwise identical but does not include a binder was also determined. Table 1 summarizes the pencil hardness.

TABLE 1

| | Silicone | |
|---|---|---|
| Silicone | Oligomer | Pencil |
| Oligomer | concentration | hardness |
| 2403 | 10% | 6H |
| | 8% | 5H |
| | 5% | H |
| | 3% | H |
| KR 500 | 10% | 6H |
| | 8% | 5H |
| | 5% | 2H |
| | 3% | H |
| MSE 100 | 10% | 6H |
| | 8% | 6H |
| | 5% | H |
| | 3% | H |
| None | | H |

As shown in Table 1, the second primary surface of a nanoparticle structure not including a binder according to the disclosure has a pencil hardness of H. The pencil hardness of the second primary surface of the nanoparticle structure can be significantly enhanced by including a binder. As can be seen in Table 1, the pencil hardness of the second primary surface generally increases as the concentration of silicone oligomer in the applied solution and ultimately in the binder, increases.

The refractive index of the oxide nanoparticle structures including the binder can be used to determine the amount of interior pore volume occupied by the binder (i.e., the fill fraction of the binder). Prior to introduction of the binder, the nanoparticle structures had an interior pore volume of about 30% and a refractive index of about 1.31. For the samples prepared from a 10% solution of silicone oligomers, the refractive index was 1.38, corresponding to about 50% of the interior pore volume being occupied (filled) with the binder. Refractive index was determined by spectroscopic ellipsometry. As the interior pore volume of the nanoparticles structures prior to introduction of the binder was 30%, and approximately 50% of the interior pore volume was occupied by binder, the remaining interior pore volume that was vacant and available to be filled with other functional materials was around 15%, based on the total volume of the nanoparticle structure. By controlling the concentration of the silicone oligomers in the solution applied to the nanoparticle structures, the fraction of the interior pore volume filled with the binder can be controlled. In general, as the concentration of the silicone oligomer increases, the fraction of interior pore volume filled by the binder increases.

TiO₂ nanoparticle structures were prepared, infiltrated with poly(dibutyltitanate), and cured in a similar manner to provide TiO₂ nanoparticle structures including titanium oxide binder in the interior pore volume and covalently bonded to at least a portion the TiO₂ nanoparticles. The refractive index of the resulting structure was greater than 2.0.

Thus, Example 2 demonstrates preparing a structure of the disclosure including a nanoparticle structure and a binder provided in the interior pore volume and covalently bonded to at least a portion of the oxide nanoparticles of the nanoparticle structure.

### Example 3—Preparation of Structures Having Highly Durable ETC Properties

SiO₂ nanoparticle structures having thicknesses of about 500 nm and binder provided in the interior pore volume were prepared on a Si/glass substrate in the same way as the nanoparticle structures prepared in Examples 1 and 2. SiO₂ nanoparticle structures with SiO₂ nanoparticles of different average diameters were prepared. The nanoparticle structures had an interior pore volume of about 30%, which was 50% occupied by the binder, leaving 50% of the interior pore volume (or 15% of the nanoparticle structure) available to be filled with an ETC compound. The nanoparticle structures each had a first primary surface in contact with the substrate and a second primary surface opposite the first primary surface.

A first comparative example was prepared by dip coating bare GG3 glass in a 1 wt. % solution of modified PFPE (Optool UD 509, Daikin Chemical Europe GmbH) in 3M NOVEC™ HFE-7200 solvent. The sample was cured at 200° C. after dipping. Abrasion testing using cheesecloth with 7.5 N loading was performed to evaluate the abrasion resistance of the ETC. After 100,000 cycles of abrasion the water-contact angle (WCA) of the second primary surface was determined to be greater than 100, as determined by ASTM D7490.

A second comparative example was prepared by dip coating an SiO₂ nanoparticle structure in the 1% solution of modified PFPE in HFE-7200 solvent. The sample was cured at 200° C. after dipping. The abrasion resistance was tested using cheesecloth with 7.5 N loading. After 1000 cycles of abrasion the WCA of the second primary surface was determined according to ASTM D7490 and was 65 degrees. Without intending to be bound by theory, it is believed that surface roughness has a negative effect on the bonding of ETC compounds on glass surfaces and, because samples with nanoparticle structures have an intrinsically larger “roughness” than bare glass, the ETC compounds do not bond as strongly to the nanoparticle structures as to the bare glass, resulting in significantly decreased abrasion resistance.

Further, without intending to be bound by theory, it is believed that because the molecular structure of the ETC is a methoxy-terminated silane with a long perfluoropolyether tail, the large tail of the ETC molecule can block the reaction sites, particularly on rougher surfaces, and the Si—OMe groups on the ETC molecule have a lower affinity to surface hydroxyl groups than a hydroxyl-terminated silane, contributing to decreased bonding to the nanoparticle structure relative to a bare glass substrate.

To enhance the bonding of the ETC on the nanoparticle structure, after applying the ETC solution to the nanoparticle structure a pre-treatment was performed prior to curing. The purpose of the pre-treatment was to hydrolyze the Si—OMe groups and relax the perfluoropolyether tail. Pretreatment consisted of either a long-term ambient storage or a short term, high temperature, high humidity treatment (85° C./85% RH, noted as 85/85).

Samples were prepared by drop casting 1 ml of the 1% solution of modified PFPE in HFE-7200 solvent onto SiO₂ nanoparticle structures. The refractive indices of the samples were about 1.412 for all samples, close to the theoretical value of SiO₂ nanoparticle structures wherein the interior pore volume is fully filled, 1.418. The resulting structures were pre-treated as described in Table 2, followed by curing. The abrasion resistance was tested using cheesecloth with 7.5 N loading, using the number of abrasion cycles provided in Table 2. The WCA of the second primary surfaces was determined and are shown in Table 2. Table 2 also provides the concentration of silicone oligomer in the solution used to apply the binder to the nanoparticle structure.

TABLE 2

| | Coating | Pre- | Abrasion | WCA |
|---|---|---|---|---|
| Sample | method | treatment | cycles | (degrees) |
| 20 nm NP, | dip | No | 1k | 65 |
| 10% 2403 | drop | Ambient | 150k | 85 |
| | | 72h | | |
| | | 85/85 20h | 150k | 109 |
| 11 nm NP, | drop | 85/85 20h | 200k | 115 |
| 10% 2403 | | | | |
| 11 nm NP. | | | 200k | 107 |
| 8% 2403 | | | | |
| 11 nm NP. | | | 200k | 113 |
| 5% 2403 | | | | |
| 11 nm NP. | | | 200k | 102 |
| 3% 2403 | | | | |

As shown in Table 2, pre-treating the structure prior to curing the ETC effectively enhances the durability of the ETC. The 85/85 pre-treatment resulted in significant increases to the durability of the ETC, indicating that the high humidity and high temperature treatment accelerated the hydrolysis and reorientation of the ETC molecules before curing. While the effect of ambient storage as a pre-treatment was less significant than the 85/85 treatment, it is believed that longer storage times would lead to further increases in durability.

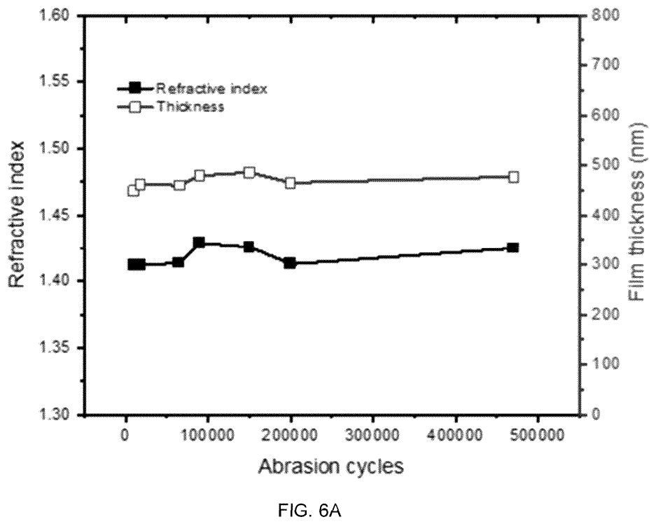

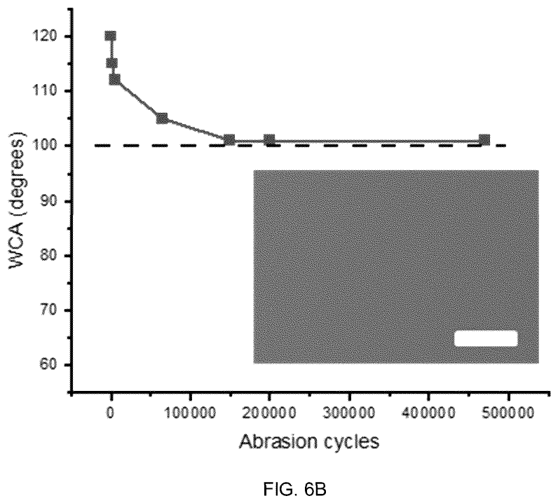

FIG. 6 shows the evolution of coating thickness, refractive index, and WCA during abrasion testing for up to 500k cycles (1 million single strips) of samples subjected to the 85/85 pre-treatment. The stable refractive index and thickness (FIG. 6A) indicate no damage or removal of the ETC. The SEM image after 500k abrasion cycles (inset of FIG. 6B) shows no visible scratch on the surface. It is believed that because the bonding site of most ETC molecules are buried in the NP stacking, the abrasion cannot completely remove the ETC molecules without damaging the whole film. This special “rooting” mechanism makes the ETC highly resistant to abrasion.

Example 3 demonstrates preparation of a structure of the disclosure including a nanoparticle structure having a binder and a functional filler (easy-to-clean composition) provided in the interior pore volume of the nanoparticle structure. Example 3 further demonstrates that a durable ETC surface can be prepared using the structures of the disclosure.

### Example 4—Preparation of Structures Having Anti-Fogging Properties

SiO₂ nanoparticle structures having thicknesses of 100 nm or 400 nm were prepared on a Si/glass substrate in the same way as the nanoparticle structures prepared in Example 1. Binder was included in some SiO₂ nanoparticle structures, as described in Example 2, while some SiO₂ nanoparticle structures were used without binder. The nanoparticle structures had an interior pore volume of about 30%. For the samples including binder, 50% of the interior pore volume was occupied by the binder, leaving 50% of the interior pore volume (or 15% of the nanoparticle structure) available to be filled with a hydrophilic compound. The nanoparticle structures each had a first primary surface in contact with the substrate and a second primary surface opposite the first primary surface.

The SiO₂ nanoparticle structures were treated with air plasma to activate the surface of the nanoparticles. Hydrophilic silanes were then introduced as a reactive filler. Two different hydrophilic silanes were tested: a nonionic trimethoxysilylpropoxypolyethyleneoxide, methyl ether (noted as PEG-silane, MW 459-591) and a zwitterionic 3-{[dimethyl (3-trimethoxysilyl) propyl]ammonio}propane-1-sulfonate (noted as ionic silane). The structure of the two silanes is shown below:

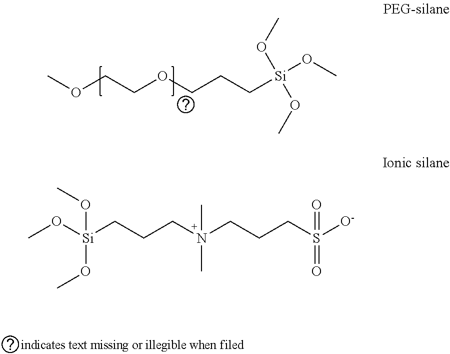

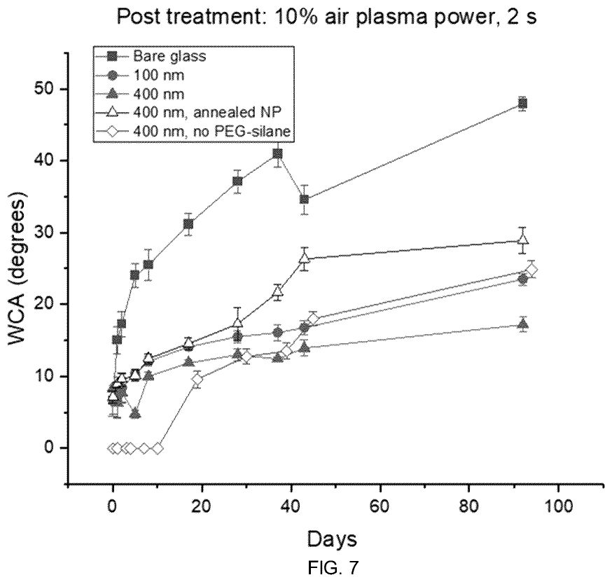

A 1 wt. % solution of PEG-silane in ethanol was dip coated on SiO₂ nanoparticle structures with and without binder. The PEG-silane was then cured at 150° C. for 4 hours. For samples including binder, the internal pore volume after inclusion of the PEG-silane was in a range of 10-25%, by volume, based on the total volume of the nanoparticle structures. After curing, the samples were rinsed with water to remove any unconnected silanes. It was observed that the samples did not have superhydrophilicity, presumably because of the dense packing of the long tails. Therefore, mild air plasma treatment (10% plasma power, 2 s) was used to further oxidize part of the PEG-silane. The samples were left open to air, and the WCA of the second primary surfaces were obtained over time to observe the lifetime. FIG. 7 shows the evolution of WCA of the samples prepared without a binder. The 100 nm and 400 nm thick samples (FIG. 7, filled circles and filled triangles) showed much longer superhydrophilicity lifetime compared with bare glass (FIG. 7, filled squares). As shown in FIG. 7, the thickness of the nanoparticle structure played an important role in the hydrophilicity, with thicker nanoparticle structures demonstrating better hydrophilicity and longer lifetimes. Without intending to be bound by theory, it is believed that the interior pore volume of the nanoparticle structure promotes water transportation in the bulk of the films and, therefore, thicker nanoparticle structures have more internal pore volume available to distribute a water droplet. Further, without intending to be bound by theory, it is believed that pore volume deeper in the nanoparticle structure (i.e., closer to the substrate than to the second primary surface) are less accessible and, therefore, less sensitive to contaminants in air, which results longer hydrophilicity lifetime.

An SiO₂ nanoparticle structure that was otherwise identical to the 400 nm sample except included no PEG-silane was tested for hydrophilicity and lifetime in the same manner as a comparison. As shown in FIG. 7 (open diamond), this pure nanoparticle structure with no PEG-silane filler showed better hydrophilicity at the beginning, the sample was more easily contaminated, and the hydrophilicity decreased quickly over the lifetime due to larger interior pore volumes (not occupied with binder and/or filler) and surface energy. For these samples, the WCA increased faster than for the PEG-silane filled sample.

The effect of surface condition of the second primary surface of the nanoparticle structure was probed by annealing the nanoparticle structure at 400° C. for 30 minutes prior to introducing the PEG-silane filler. At the annealing temperature, the surface Si—OH groups of the SiO₂ nanoparticles can condense to Si—O—Si groups. It was found that annealing the nanoparticle structure prior to introducing the PEG-silane filler resulted in higher WCA and shorter hydrophilicity lifetime, indicating inefficient bonding of the PEG-silane (FIG. 7, open triangle).

The effect of an ionic silane on the hydrophilicity was investigated. Without intending to be bound by theory, it is believed that the ionic nature of the silane renders it very hydrophilic while the overall neutral charge of the silane prevents adsorption of other charged species, thereby maintaining stability.

SiO₂ nanoparticles structures having a thickness of 400 nm and including a binder prepared from Dowsil™ 2403 were prepared as in Example 2 to enhance the mechanical properties. Some samples were treated with the 85/85 pre-treatment described in Example 3, prior to introduction of the ionic silane, to facilitate the bonding between the ionic silane at the SiO₂ nanoparticles.

The ionic silane was deposited on the nanoparticle structures by either dip coating or drop casting a 1 wt. % solution of ionic silane in water. The ionic silane was cured at 150° C. for 4 hours. The samples were sonicated in DI water to remove any unbonded ionic silane. Dip coated ionic silane on bare glass was prepared as reference. The sample information and initial WCA are summarized in Table 3.

TABLE 3

| Sample | | | Coating | Pre- | | |
|---|---|---|---|---|---|---|
| # | NP | Binder | method | treatment | Initial WCA | |
| 1 | 20 nm | 2403 | Dip | N/A | WCA | 11 |
| | SiO₂ | | | | err | 1 |
| 2 | NP | | | 85/85 | WCA | 0 |
| | | | | | err | 0 |
| 3 | | N/A | | N/A | WCA | 9 |
| | | | | | Err | 3 |
| | | | | | Partially damaged | |
| 4 | | | | 85/85 | Damaged | / |
| 5 | | 2403 | Drop | N/A | WCA | 3 |
| | | | | | err | 1 |
| 6 | | | | 85/85 | WCA | 65 |
| 7 | | N/A | | N/A | WCA | 10 |
| | | | | | err | 4 |
| 8 | | | | 85/85 | Damaged | / |
| 9 | Bare | N/A | Dip | N/A | WCA | 24 |
| 10 | glass | | Dip | 85/85 | WCA | 50 |

As shown in Table 3, the ionic silane could not generate superhydrophilicity on bare glass, despite the preparation method (Samples 9, 10). Further, because of weak bonding between the nanoparticles, most of the samples prepared without binder were severely damaged during the sonication step (Samples 3, 4, 8). All of the samples that included binder survived sonication and demonstrated good resistance to cloth wiping (Samples 1, 2, 5, 6). The 85/85 pre-treatment had varying impact depending on the coating method of the ionic silane. Comparing Samples 1 and 2 (dip coated), the 85/85 treatment (Sample 2) significantly increased the hydrophilicity. However, comparing Sample 2 (dip coated) and Sample 6 (drop-cast), the drop-cast method provided very high WCA (lower hydrophilicity). Without intending to be bound by theory, it is believed that the higher loading of ionic silane deposited with the drop-cast method made it easier for self-condensation rather than bonding on the nanoparticle surface with the 85/85 pre-treatment. This phenomenon further confirms that the 85/85 pre-treatment can significantly increase the reactivity of the silanes in the curing step that follows.

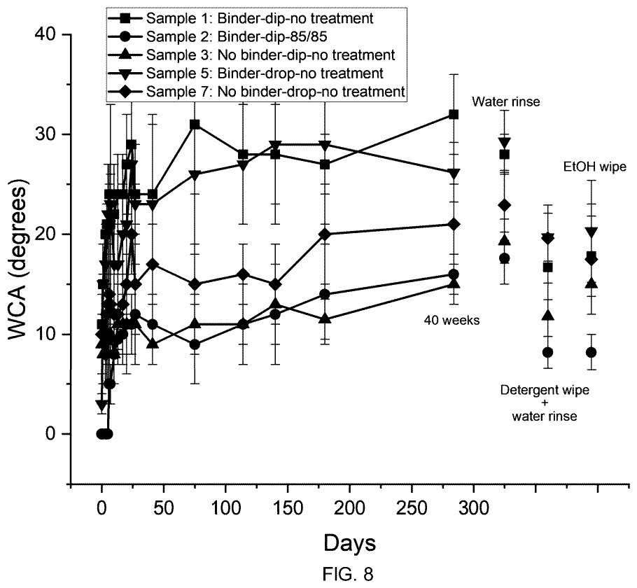

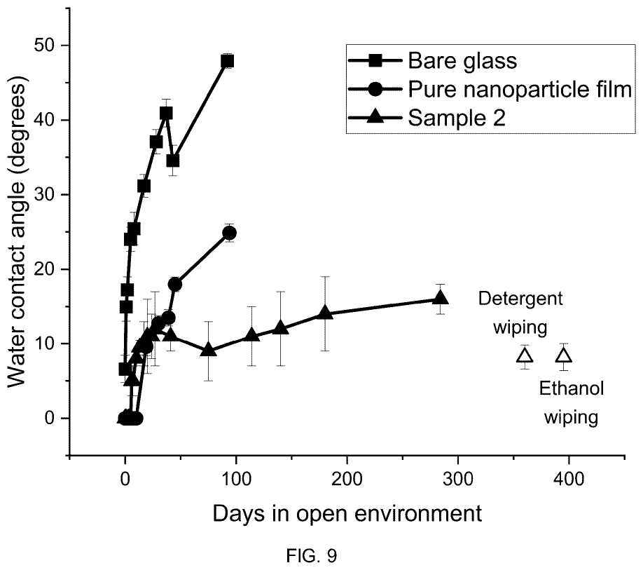

Samples that showed superhydrophilicity and were not completely damaged during sonication (Samples 1, 2, 3, 5, 7) were left open to air, and the WCA of the second primary surfaces were obtained over time to observe the lifetime. The evolution of WCA is shown in FIG. 8. As shown in FIG. 8, after an initial increase of WCA in the first few days, the WCA value became very stable for up to 40 weeks. The final value depended on the sample preparation method. The binder dip 85/85 sample (Sample 2, FIG. 8 filled circle) demonstrated the best hydrophilicity lifetime. The WCA remained lower than 15 degrees after 40 weeks. FIG. 9 shows a comparison of the hydrophilic lifetime of Sample 2, bare glass, and a pure nanoparticle film (including no binder or filler). FIG. 9 shows a significant improvement in hydrophilic lifetime for a structure of the disclosure relative to bare glass or pure nanoparticle film.

Because the adsorption of contaminants from air is inevitable, it was important that the coating could be easily cleaned to recover the superhydrophilicity. After the 40 week lifetime test, different cleaning methods were applied to the samples. The samples were cleaned with a water rinse, a detergent wipe and water rinse, or an ethanol wipe. The WCA after cleaning and drying are marked in FIG. 8. It can be seen that the superhydrophilicity of Sample 2 was recovered with detergent wiping and water rinsing or ethanol wiping. No damage was observed after the cleaning.

Example 4 demonstrates preparation of a structure of the disclosure including a nanoparticle structure having a binder and a functional filler (hydrophilic compound for anti-fogging applications) provided in the interior pore volume of the nanoparticle structure. Example 4 further demonstrates that a durable, recoverable superhydrophilic surface can be prepared using the structures of the disclosure.

It will be apparent to those skilled in the art that various modifications and variations can be made without departing from the spirit or scope of the claimed subject matter. Accordingly, the claimed subject matter is not to be restricted except in light of the attached claims and their equivalents.

What is claimed is:

1. A structure, comprising:
a nanoparticle structure comprising:
a first primary surface and a second primary surface opposite the first primary surface;
one or more layers of oxide nanoparticles disposed between and constituting the first and second primary surfaces;
an interior pore volume located in spaces between oxide nanoparticles; and
a binder provided in the interior pore volume and covalently bonded to at least a portion of the oxide nanoparticles.

2. The structure of claim 1, wherein the oxide nanoparticles comprise SiO₂, ZrO₂, TiO₂, Al₂O₃, MgO, HfO₂, ZnO or any combination thereof.

3. The structure of claim 1, wherein the nanoparticle structure comprises two or more layers of oxide nanoparticles, and wherein the oxide nanoparticles of the two or more layers of oxide nanoparticles are substantially the same.

4. The structure of claim 1, wherein the structure comprises a first layer of oxide nanoparticles and a second layer of oxide nanoparticles, wherein the oxide nanoparticles in the first layer are substantially the same and the oxide nanoparticles in the second layer are substantially the same but different from the oxide nanoparticles in the first layer.

5. The structure of claim 4, wherein the nanoparticle structure comprises alternating layers of the first layer of oxide nanoparticles and the second layer of oxide nanoparticles.

6. The structure of claim 1, wherein the nanoparticle structure has a thickness in a range of 5 nm to 5000 nm.

7. The structure of claim 1, wherein the interior pore volume accounts for 10% to 50%, by volume, of a total volume of the nanoparticle structure.

8. The structure of claim 1, wherein the nanoparticle structure has a volume fraction of nanoparticles of 52-74 vol. %.

9. The structure of claim 1, wherein the binder comprises a matrix structure comprising reacted silicone oligomer, reacted inorganic oxide, or a combination thereof.

10. The structure of claim 1, wherein 10% to 100%, by volume, of the interior pore volume is occupied by the binder.

11. The structure of claim 1, further comprising a functional filler covalently bonded to at least a portion of the oxide nanoparticles, at least a portion of the binder, or both.

12. The structure of claim 11, wherein the functional filler comprises an easy-to-clean (ETC) compound or a hydrophilic compound.

13. The structure of claim 11, wherein 10% to 50%, by volume, of the interior pore volume is occupied by the functional filler.

14. The structure of claim 1, wherein the structure further comprises a substrate and the nanoparticle structure is provided on at least one surface of the substrate.

15. The structure according to claim 1, wherein the structure is transparent and/or antireflective.

16. A method of preparing a structure, the method comprising:
(i) depositing a nanoparticle structure on a substrate, wherein the nanoparticle structure comprises:
a first primary surface and a second primary surface opposite the first primary surface, the first primary surface being proximal to the substrate;
one or more layers of oxide nanoparticles disposed between and constituting the first and second primary surfaces; and
an interior pore volume located in spaces between oxide nanoparticles;
(ii) infiltrating the interior pore volume with a reactive binder; and
optionally (iii) removing the nanoparticle structure from the substrate.

17. The method of claim 16, wherein the method further comprises:
(iv) infiltrating the interior pore volume with a functional filler and providing a layer of functional filler on the second primary surface of the nanoparticle structure.

18. The method of claim 16, wherein the depositing comprises depositing one or more compositions comprising oxide nanoparticles on the substrate, and the one or more compositions comprising oxide nanoparticles, the reactive binder, and the functional filler are independently deposited by spin-coating, dip-coating, spray-coating, bar-coating, screen-coating, slot-die coating, blade-coating, inkjet printing, or any combination thereof.

19. The method of claim 16, further comprising curing the reactive binder and/or the functional filler at a temperature in a range of 20° C. to 400° C. for a time in a range of 5 minutes to 2 weeks.

20. The method of claim 19, further comprising conditioning the structure at ambient conditions for a time in a range of 10 minutes to 2 weeks or conditioning the structure at a temperature in a range of 60° C. to 100° C. and a humidity of 60% to 100% relative humidity for a time in a range of 12 hours to 24 hours prior to curing the functional filler.
